(19) United States
(12) Patent Application Publication
(10) Pub. No.: US 2007/0210542 A1
(43) Pub. Date: Sep. 13, 2007

(54) Method and apparatus for moving a pallet

(75) Inventor: Ronald J. Hammond, Charlotte, NC (US)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Swift Water Logistics, Inc., Charlotte, NC (US)

(21) Appl. No.: 11/712,693

(22) Filed: Mar. 1, 2007

Related U.S. Application Data
(60) Provisional application No. 60/781,449, filed on Mar. 10, 2006.

(51) Int. Cl. B62D 21/14; B62B 1/00

(52) U.S. Cl. 280/43.12; 254/1; 414/490

(57) ABSTRACT

An apparatus for moving a pallet having a wheeled frame supporting a lift plate. The lift plate is raised by inflation of bladders disposed beneath the lift plate and lowered by deflation of the bladders. A fluid supply system provides pressurized gas for bladder inflation. Gas operated brakes resist apparatus movement when engaged. A method of moving a pallet in which a wheeled lift plate is positioned between a surface and a pallet, bladders disposed beneath the lift plate are inflated to raise the lift plate and thereby raise the pallet off of the surface, the raised lift plate supporting the pallet is rolled to a desired location, and the lift plate is lowered by deflating the bladders until the pallet rests on the surface at the desired location. A method of delivering palletized beverages is also disclosed.

### CROSS-REFERENCE TO RELATED APPLICATION

This application is entitled to the benefit of, and claims priority to, provisional U.S. Patent Application Ser. No. 60/781,449 filed Mar. 10, 2006 and entitled “Pallet Lifting and Moving Apparatus,” the entirety of which is incorporated herein by reference.

### TECHNICAL FIELD

The present invention relates generally to a method and apparatus for moving a loaded pallet, and, in particular, to a method and apparatus for moving a loaded pallet by means of a gas-operated lift system.

### BACKGROUND

Pallets and similar structures are typically used to transport articles from one location to another in a quick and efficient manner. Often, products are loaded onto pallets at the end of a manufacturing process. The loaded pallets are then moved to various locations in the manufacturing facility for subsequent storage or shipment.

Pallets are widely used in the beverage industry. High-speed beverage production lines, which can produce 20, 50, 100 or even more beverage cases per minute, rapidly produce large quantities of canned and bottled beverage cases, which are stacked on pallets. But many beverage customers—and especially the so-called direct store delivery (“DSD”) customers—do not require an entire pallet of any one beverage type. Instead, these customers require that cases of various types of beverages be delivered to their stores.

To accommodate such customer demand, beverage producers typically use forklifts and conventional pallet trucks, such as the pallet truck disclosed in U.S. Pat. No. 3,982,767 to Larsson et al., to move pallets of different beverages (each loaded with only a single beverage type) to a particular location in the manufacturing facility and then “pick” cases from each of the loaded pallets that are needed to fulfill customer orders. The “picked” cases are loaded into the side bays of a beverage delivery truck. Because the bays of a conventional beverage delivery truck are not large enough to accommodate a standard sized pallet, individual beverage cases are loaded in the truck side bays.

Once a beverage delivery truck is loaded, a delivery person drives the beverage truck to various customer locations for delivery. At each customer location, the delivery person retrieves cases of beverages from the various truck side bays that are needed to fill the customer's order and delivers those cases to the customer's store. The delivery person typically uses a conventional hand truck when moving beverage cases from the delivery truck to the store. One conventional hand truck is disclosed in U.S. Pat. No. 4,114,916 to Oyama.

Because of the limited number of cases that can be carried safely on a conventional hand truck, a delivery person must often make multiple trips between the beverage truck and the customer store when delivering a customer order, thus making the delivery process very inefficient. Moreover, if the customer location contains inclines or uneven surfaces, even less cases than normal can be safely loaded on the hand truck and thus even more trips between the customer's store and the beverage truck are required to unload the customer's order.

In addition, the conventional delivery process described above is hard work and can result in personal injuries. Beverage cases—especially cases of 2 liter beverages—are heavy and the truck side bays are often loaded with cases to a height that is over the delivery person's head. The delivery person is thus often forced to reach high into a side bay, grab a heavy beverage carton and then carry that carton from the side bay down to a hand truck on ground level. Not surprising, this results in a number of back, shoulder and other injuries.

Accordingly, a need exists in the art for an apparatus capable of transporting a large number of beverage cases in a safe and efficient manner from a delivery truck to a customer's store. In addition to being maneuverable enough for use in a typical retail store environment, such an apparatus should advantageously minimize the amount of manual lifting of cases required to complete the delivery process. The present invention is provided to address these and other concerns and to provide advantages that are not provided by known pallet trucks and hand trucks.

### SUMMARY

The present invention overcomes the difficulties and disadvantages associated with using conventional hand trucks to move beverage cases between a side bay delivery truck and a customer's store by providing a new pallet lifting and moving apparatus and new method of distributing palletized products, such as palletized beverages.

A pallet lifting and moving apparatus includes a wheeled frame having a handle, a lift plate that moves between a lower or first position and a raised or second position, and one or more inflatable bladders between the lift plate and a portion of the frame. In a preferred embodiment, two spaced inflatable bladders are mounted to the upper side of an elongate portion of the frame and wheels are mounted to the lower side of the elongate portion of the frame. Inflation of the bladders raises the lift plate from the first position to the second position. A stabilizing plate may be provided to ensure that the lift plate remains substantially horizontal during movement of the lift plate between the first position and the second position.

When the lift plate is positioned between the surface on which a pallet rests and the deck portion of a pallet, raising the lift plate by inflating the bladders moves the lift plate into contact with the pallet and thereby lifts the pallet off of the surface when the lift plate is in the second position. The pallet can then be moved by pushing or pulling the handle to roll the frame over the surface with the pallet supported thereon by the lift plate.

In a preferred embodiment, a fluid supply system having a tank of pressurized liquid, one or more regulators to reduce pressure in the fluid supply system downstream of the regulators to a pressure at which the liquid in the tank becomes a gas, and valve in fluid communication with the regulators and the bladders provides a supply of gas to inflate the inflatable bladders. When the valve is open, gas in the fluid supply system downstream of the regulators is permitted to flow into and inflate the bladders. The valve may have three positions, namely, a first position that permits gas in the fluid supply system to flow into the bladders, a second position that does not permit gas to flow into or out of the bladders, and a third position that permits gas to flow out of the bladders.

Carbon dioxide may be advantageously used in the present invention as the pressurized liquid, which becomes a gas downstream of the regulators. The supply tank may be a carbon dioxide cylinder as is commonly used in the beverage industry. A liquid accumulator may be provided in the fluid supply system downstream of one or all of the regulators.

In a preferred embodiment, one or more brakes are provided. Each brake has a brake shoe and a gas operated brake cylinder in fluid communication with the regulators. Each brake is adapted and positioned such that pressurized gas entering the gas operated brake cylinder moves the brake shoe into contact with a wheel. A brake valve in fluid communication with the regulators and the brake is provided. Opening the brake valve permits gas in the fluid supply system to flow into the brake cylinder and move the brake shoe into contact with a wheel. The brake valve may have two positions, namely, a first position that permits gas in the fluid supply system to flow into the gas operated brake cylinder and a second position that permits gas to flow out of the gas operated brake cylinder.

Manual valve actuators or actuator control switches controlling the bladder inflation valve and the brake valve may be located on a control panel supported on the apparatus frame. In a preferred embodiment, the control panel is positioned atop a housing that encloses a portion of the fluid supply system.

Each wheel may have the same diameter or, alternatively, one or more wheels may have a larger diameter than the other wheels. Having one or more wheels of larger diameter may facilitate rocking the apparatus as may be needed to move the apparatus over rough ground or over a door threshold. One or more wheels may be mounted such that they swivel to assist in apparatus maneuverability.

The apparatus of the present invention may be advantageously utilized in a new method of delivering palletized beverages, in which: one or more pallets loaded with beverages corresponding to beverages ordered by a customer are positioned on the floor of a delivery truck, the truck is driven to a customer's location, a lifting plate is rolled between the floor of the delivery truck and a loaded pallet, the lifting plate is raised by inflating one or more inflatable bladders beneath the lifting plate and as the lifting plate rises it contacts and lifts the pallet off of the delivery truck floor, and then the raised lifting plate and the pallet supported thereon are rolled from the delivery truck to the customer's building. Once inside the customer's building, the lifting plate is lowered by deflating the bladders beneath the lifting plate and the pallet supported by the lifting plate is thereby lowered until the pallet comes to rest on the floor of the customer's building. The lifting plate can then be rolled out from beneath the pallet and used for subsequent deliveries.

In a preferred embodiment, the lifting plate is disposed on a wheeled frame and one or more inflatable bladders are disposed between the lifting plate and a portion of the wheeled frame such that inflation of the bladders using pressurized gas raises the lifting plate.

In a preferred embodiment, the wheeled frame also includes a supply of pressurized gas to inflate the inflatable bladders. Carbon dioxide may be advantageously be used as the pressurized gas.

As is evident from the foregoing summary, the present invention relieves beverage delivery personnel of the need to undertake the time consuming, difficult and sometimes dangerous task of lifting heavy beverage cases from delivery truck side bays and then moving those cases into a store using a conventional hand truck. Using the present invention, delivery personnel can henceforth make store deliveries in a quick and relatively easy manner by lifting and moving palletized loads from a conventional delivery truck (not a side bay delivery truck) directly into store locations.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

For a more complete understanding of this invention reference should now be had to the preferred embodiments illustrated in greater detail in the accompanying drawings and described below. In the drawings, which are not necessarily to scale:

FIG. 1 is a perspective view of an apparatus for moving a pallet, with the lift plate thereof in a first position;

FIG. 2 is a perspective view of the apparatus of FIG. 1, with the lift plate thereof in a second position;

FIG. 3 is a perspective view of the apparatus of FIG. 2 with a loaded pallet positioned thereon;

FIG. 4 is a schematic illustration showing a fluid supply system of the present invention;

FIG. 5 is a perspective view of the apparatus of FIG. 1 taken along the 5-5 line of FIG. 1, with the housing door open to show various components therein;

FIG. 6 is a partial top view of the apparatus of FIG. 1 showing the control panel;

FIG. 7 is a partial sectional view of the apparatus of FIG. 2 taken along the 7-7 line of FIG. 2 and a pallet disposed thereon;

FIG. 8 is a partial sectional view of the apparatus of FIG. 2 taken along the 8-8 line of FIG. 2 and a pallet disposed thereon;

FIG. 9 is a plan view of a wheel of the apparatus of FIG. 1 with the wheel brake in a retracted position;

FIG. 10 is a plan view of a wheel of the apparatus of FIG. 1 with the wheel brake in a braking position; and

FIG. 11 is a bottom view of the apparatus of FIG. 1.

### DETAILED DESCRIPTION

The present invention will now be described fully hereinafter with reference to the accompanying drawings, in which preferred embodiments of the invention are shown. This invention may, however, be embodied in many different forms and should not be construed as limited to the preferred embodiments set forth herein. Rather, these preferred embodiments are provided so that this disclosure will be thorough and complete, and will fully convey the scope of the invention to those skilled in the art. It will be understood that all alternatives, modifications, and equivalents are intended to be included within the spirit and scope of the invention as defined by the appended claims.

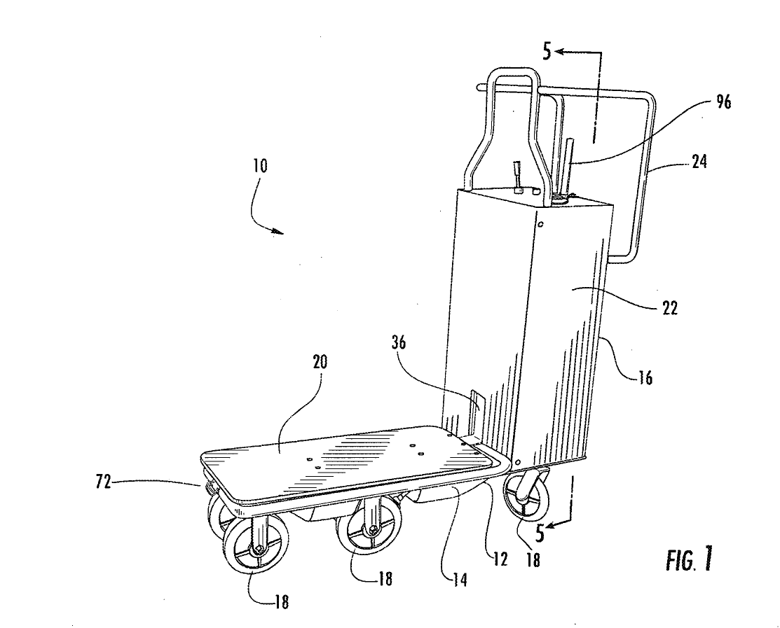

As shown in FIGS. 1-3, a pallet lifting and moving apparatus 10 in accordance with the present invention includes a frame 12, a plurality of wheels 18 arranged to support the frame 12 on the ground or other surface, a pallet lift plate 20, one or more inflatable bladders 26 and a fluid supply system 40.

The frame 12 includes a horizontal or elongate portion 14 and a vertical portion 16. As used herein, the “lower” side of the horizontal or elongate portion 14 is the side closest to the ground or surface upon which the apparatus rests (i.e., the side to which the wheels, which are discussed below, attach). The “upper” side of the horizontal or elongate portion 14 is the side farther away from the ground or surface upon which the apparatus rests (i.e., the side to which the inflatable bladders, which are discussed below, attach). The vertical portion 16 of the frame 12 includes a housing 22 and handlebars 24 arranged such that an individual may push, pull, guide or steer the apparatus 10 by using the handlebars 24. Although the frame 12 may be constructed of any desired material, it is preferable to construct the frame 12 of a material capable of withstanding the intended loads and prolonged usage. In a preferred embodiment suitable for use in the beverage industry, portions of the frame 12 are constructed of 1¼ inch tubular steel with wall thicknesses of approximately 83/1000 inch for the horizontal portion 14 of the frame 12 and approximately 49/1000 inch for the handlebars 24. Advantageously, use of tubular steel in portions of the frame 12 reduces the weight of the apparatus 10 as compared to using other materials.

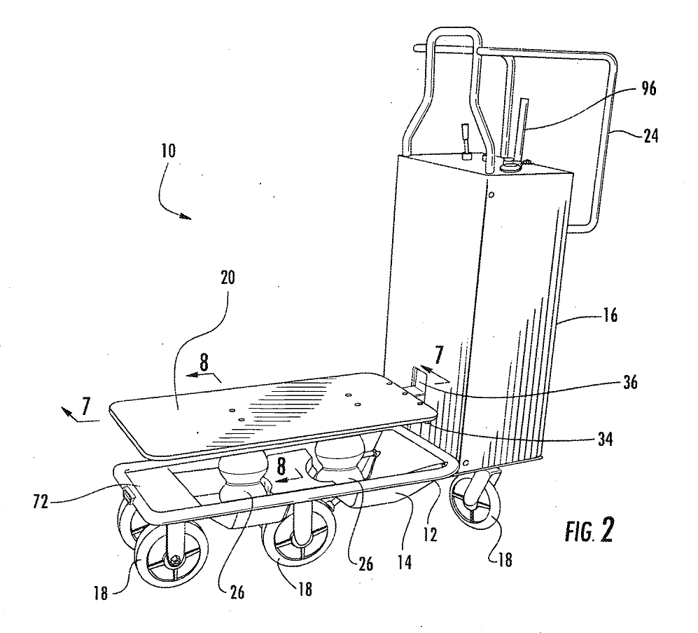

The lift plate 20 is disposed on the horizontal or elongate portion 14 of the frame 12 such that it is movable independently of the frame 12 between a first position (illustrated in FIG. 1) in which the pallet lift plate 20 is adjacent the horizontal portion 14 of the frame 12 and a second position (illustrated in FIGS. 2, 3, 7 and 8) in which the pallet lift plate 20 is spaced from the horizontal portion 14 of the frame 12. With the lift plate 20 in the first position, the apparatus 10 can be rolled under a pallet such that the lift plate 20 (or a portion thereof) is positioned beneath the upper face or surface of the pallet 70. As the lift plate 20 moves to the second position the lift plate 20 engages the pallet and supports the pallet 70 above the ground or other surface upon which the pallet originally rested. The lift plate 20 is also preferably composed of a durable material, such as steel.

Advantageously, the present invention can be of a size such that is suitable for use with a pallet having a length and width smaller than standard sized pallets. In this way the present invention can be successfully utilized for direct store delivery of mixed beverage pallets because the apparatus of the present invention is maneuverable enough and the corresponding pallet is small enough to accommodate use in many customer store facilities. A pallet having dimensions of approximately 37 inches long by 18.5 inches wide by 13.5 inches high may be used with the present invention. A particularly advantageous pallet suitable for use with the present invention is disclosed in pending U.S. patent application Ser. No. 11/343,226, which was filed on Jan. 30, 2006 and which is incorporated herein by reference.

As best illustrated by FIGS. 2, 7 and 8, one or more inflatable bladders 26 are disposed between the lift plate 20 and part of the upper side of the horizontal or elongate portion 14 of the frame 12. While any number of inflatable bladders 26 may be selected for use (including selection of a single bladder), a pair of spaced apart inflatable bladders 26 has been found to enhance stability of the apparatus 10. Introduction of a pressurized gas into the inflatable bladders 26 causes the bladders 26 to inflate and thus expand. Through such expansion, the inflatable bladders 26 move the lift plate 20 from the first position to the second position. Conversely, release of the pressurized gas from the inflated bladders allows the bladders 26 to deflate, thereby causing the lift plate 20 to return from the second position to the first position by operation of gravity and retraction of the inflatable bladders to their deflated size and shape.

When deflated, each of the inflatable bladders may be substantially contained within a compartment defined by the lift plate 20 and the horizontal or elongate portion 14 of the frame 12. Advantageously, the size of the bladders when deflated may be selected such that the pallet lift plate 20 rests upon the horizontal portion 14 of the frame 12 when the bladders are deflated and the lift plate 20 is in the first position.

The inflatable bladders 26 should be capable of operating properly despite multiple expansions and retractions. In selecting such bladders, care must be given to ensure that the pressure rating of the bladder 26 is not exceeded during use. In a preferred embodiment, two inflatable bladders 26 each having a pressure rating of 250 pounds per square inch (“PSI”) are used. The inflatable bladders 26 may advantageously be made of a durable and resilient material such as rubber, plastic or various suitable polymers. One type of bladder suitable for use in the present invention is a double convoluted air spring, which is readily available from a variety of manufacturers, including the Firestone Industrial Products Company in Indianapolis, Ind., which sells double convoluted air springs under the Airide brand.

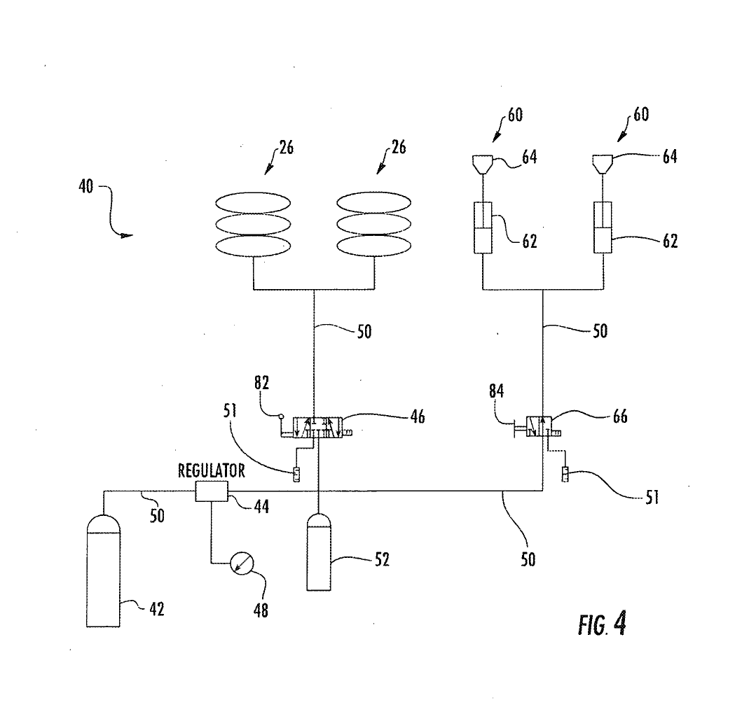

Pressurized gas to operate the inflatable bladders and brakes (discussed below) is provided by a fluid supply system 40, which is schematically illustrated in FIG. 4. As those in the art will appreciate, as used herein the word “fluid” includes both liquids and gases. While pressurized gas is used to inflate the inflatable bladders 26, both liquid and gas are contained within the fluid supply system 40.

A variety of different types of gases and liquids may be suitably used with the present invention. For example, compressed air may be used. In a preferred embodiment, carbon dioxide in both liquid and gaseous phases is utilized. A particular advantage of using carbon dioxide in the beverage industry is that it is readily available and generally known because carbon dioxide is used in many types of beverage dispensing equipment.

A supply tank 42 is preferably a carbon dioxide cylinder of the type that is commonly used in the beverage industry. Such a carbon dioxide cylinder is filled with pressurized carbon dioxide in liquid phase, although as those in the art will appreciate, a small amount of gaseous liquid dioxide may be present in the cylinder containing pressurized liquid carbon dioxide. A 20 pound cylinder of liquid carbon dioxide is particularly suitable for use as the supply tank 42. Pressure inside of such liquid carbon dioxide cylinders typically ranges from 800-2000 PSI. In a preferred embodiment, the supply tank 42 is considered “empty” or “exhausted” when pressure of the carbon dioxide inside the tank is less than approximately 500 PSI.

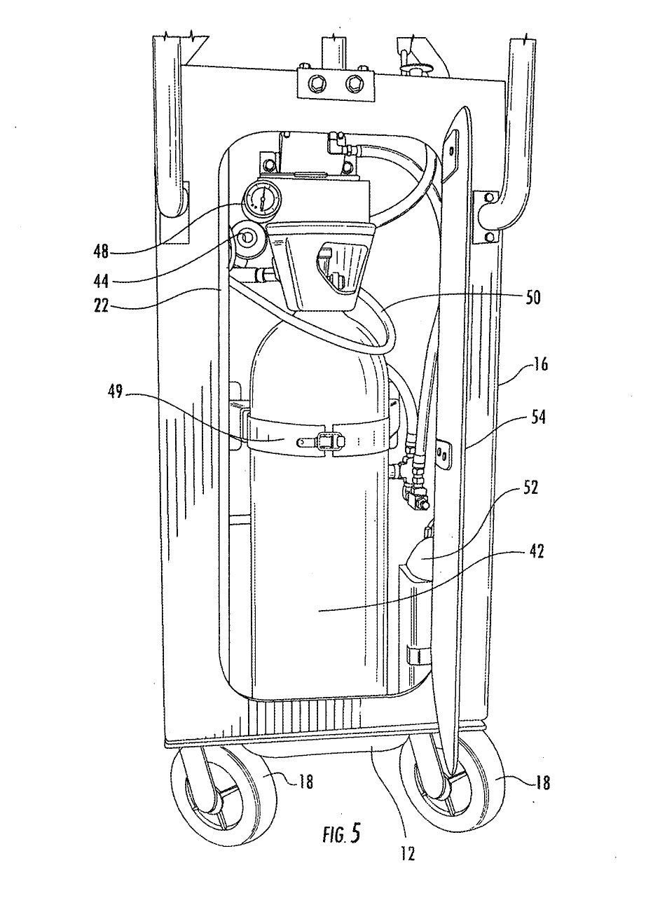

As shown in FIG. 5, the housing 22 of the vertical portion 16 of the frame 12 may enclose various components of a fluid supply system 40, including the supply tank 42. The supply tank 42 may be secured within the housing 22 by a metal band or strap 49 to ensure that the supply tank 42 remains properly secured while the apparatus 10 is in use. Fastening the supply tank 42 in this manner also enables the supply tank 42 to be replaced with relative ease when the fluid contained therein becomes substantially exhausted. An access door 54 is provided on the housing 22 to facilitate replacement and maintenance of various components of the fluid supply system 40 contained within the housing.

A pressure regulator 44 in fluid communication with the supply tank 42 is used in the fluid supply system 40 to reduce and maintain pressure of the fluid downstream of the pressure regulator 44. As used herein, components are considered to be in “fluid communication” with each other if fluid can flow between the components, either directly or through other intermediate components. The pressure to be maintained in the fluid supply system 40 downstream of the regulator 44 is selected such that the fluid downstream of the regulator 44 will be in substantially gaseous phase over the anticipated temperate range in which the apparatus will be used and in consideration of the inflation pressure needed for the inflatable bladders to lift and support a pallet and the anticipated load on the pallet.

As those in the art will appreciate, while the present application describes and illustrates only a single regulator, more than one regulator may be used within the scope of the present invention to reduce and maintain gaseous pressure in the fluid supply system. In a preferred embodiment, two pressure regulators 44 are utilized in conjunction with a liquid carbon dioxide fluid supply tank 42 such that the first pressure regulator reduces the pressure of the carbon dioxide to approximately 110 PSI and the second pressure regulator further reduces the pressure of the carbon dioxide to a pressure ranging approximately from 70 PSI to 100 PSI, and preferably between 80 PSI to 100 PSI. Thus, carbon dioxide in a liquid state in the supply tank 42 would have entered a gaseous state at 70 PSI to 100 PSI downstream of the pressure regulators 44. When the apparatus of the present invention is used to lift pallets of beverages of the type described herein, it has been found that gaseous pressures of below approximately 70 PSI in the bladders result in an inconveniently slow pallet lift time.

A liquid accumulator 52 may be provided in the fluid flow system 40 downstream of the pressure regulator 44 to collect any liquid passing through the pressure regulator 44. The liquid accumulator 52 may advantageously be a metal container or cylinder.

As shown in FIG. 4, the fluid supply system 40 includes a bladder valve 46 downstream of the pressure regulator 44 to control the flow of pressurized gas into and out of the inflatable bladders 26. The bladder valve 46, which is operated from the control panel 80, may be of any suitable type. Advantageously, a three-way valve, spool valve, shear-type-seal valve or other bidirectional valve may be used so that a single valve controls both the flow of pressurized gas into the bladders 26 in order to inflate the bladders 26 and the release of pressurized gas from the bladders 26 in order to deflate the bladders 26. Alternatively, separate valves could be used to control the flow of pressurized gas into the bladders 26 and the release of pressurized gas from the bladders 26.

Mufflers 51, flow restrictors or orifices may be disposed in the flow path of gas released from the inflatable bladders 26 to control the flow rate of such gases and attenuate the associated noise.

Piping or tubing 50 is used in the fluid supply system 40 to contain and direct flow of the operating fluid to and from the various components in the system. Such tubing and the connections between the tubing and various system components must accommodate the selected system operating pressure and must be suitable for use with the selected operating fluid. In a preferred embodiment, the tubing 50 is composed of a rubber, plastic or polymeric material.

At various points in the fluid supply system 40, one or more pressure gauges 48 may be positioned to monitor the pressure of the pressurized fluid in the fluid supply system 40. In a preferred embodiment, pressure gauges 48 are used to monitor pressure in the supply tank and downstream of the regulator 44.

Turning now to operation of the inflatable bladders 26, when the apparatus 10 is not in use, no pressurized gas is in the inflatable bladders 26 and the pallet lift plate 20 is in the first position. When it is desired to raise the lift plate 20, the bladder valve 46 is actuated using a manual actuating lever 82 on the control panel to move the bladder valve 46 to open a flow path for pressurized gas to flow into the inflatable bladders 26. Introduction of the pressurized gas into the inflatable bladders 26 causes the bladders 26 to inflate and expand, thereby moving the lift plate 20 from the first position to the second position in which the lift plate is spaced from the horizontal portion 14 of the frame 12. Once inflated, the manual actuating lever 82 may be returned to the neutral position, thereby moving the bladder valve 46 to a position in which no gas can flow into or out of the bladders 26.

When it is desired to lower the lift plate 20 from the second position, the bladder valve 46 is actuated using the manual actuating lever 82 to move the bladder valve 46 to open a flow path for pressurized gas inside the inflatable bladders 26 to flow to the atmosphere outside of the apparatus. Release of the pressurized gas from the inflatable bladders 26 to the atmosphere and gravity acting upon the lift plate 20 causes the bladders 26 to deflate, thus returning the lift plate 20 from the second position to the first position.

Advantageously, in order to minimize tilting or “listing” of the lift plate during movement, a stabilizing plate 36 may be provided. As illustrated in FIGS. 1 and 2, a suitable stabilizing plate 36 may be made by affixing one “leg” of an L-shaped metal plate to a side of the lift plate 20 and positioning the other “leg” of the L-shaped plate such that it is constrained by a channel in the housing 22 during movement of the lift plate 20 between the first and second positions. If desired, a bearing assembly may be used to facilitate movable engagement between the stabilizing plate 36 and the housing 22.

As shown in FIGS. 1-3 and 11, the apparatus 10 has a plurality of wheels 18 attached to the lower side of the horizontal or elongate portion 14 of the apparatus 10 to facilitate movement of the apparatus 10 on the ground or other surface. The wheels 18 may be composed of any suitable material. In a preferred embodiment, the wheels 18 are 8″ diameter solid tires so as to reduce or eliminate excess bouncing of the apparatus 10 when rolled on an uneven surface, as may be encountered using inflatable tires. In another preferred embodiment, the wheels 18 are drum-like cylinders.

A variety of different numbers and configurations of wheels 18 may be used in the present invention. In a preferred embodiment, the apparatus 10 has three pairs of wheels 18, each mounted to the frame 12 along the underside of the horizontal or elongate portion 14. The pairs of wheels 18 are arranged such that one pair is positioned near each end of the horizontal portion 14 and one pair is positioned near the center of the horizontal portion 14.

Each wheel 18 may be sized such that the diameter of each wheel 18 is identical or such that the diameter varies among the pairs of wheels 18. In a preferred embodiment having three pairs of wheels 18, all wheels are of equal diameter. In another preferred embodiment having three pairs of wheels 18, the center pair of wheels 18 has a larger diameter than that of the other pairs of wheels 18. This configuration may allow an operator to more easily tilt the apparatus 10 when rolling it over a threshold or other obstacle.

One or more of the wheels 18 of the apparatus 10 may be adapted to swivel (i.e., the wheels may be mounted such that the wheels roll over the ground around a horizontal axis but also rotate around a vertical axis). In a preferred embodiment having three pairs of wheels 18, the pair of wheels 18 nearest the vertical portion of the frame is mounted to swivel. The inclusion of at least a pair of wheels 18 capable of swiveling facilitates greater maneuverability of the apparatus 10 in constrained spaces, such as customer stores having display shelving.

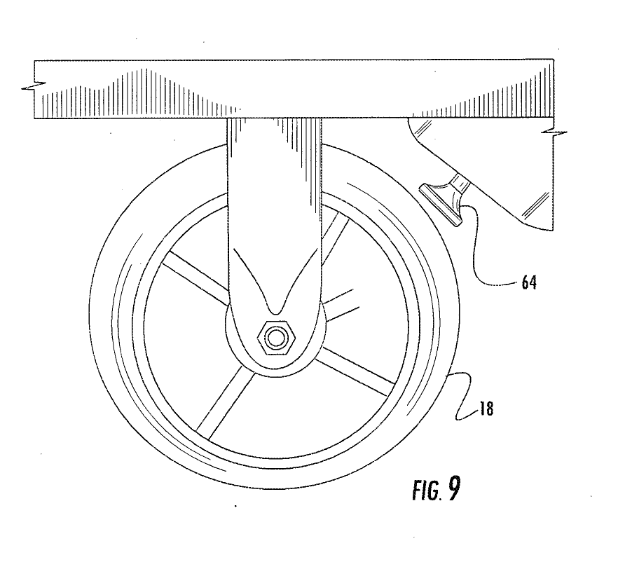

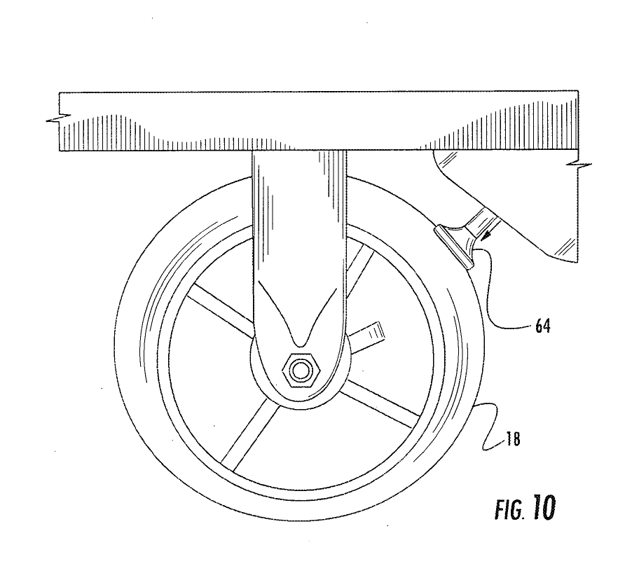

As shown in FIGS. 9-11, a wheel brake 60 may be positioned to engage one or more wheels 18 to inhibit movement of the apparatus 10. The wheel brake may be a purely mechanical brake, but in a preferred embodiment the wheel brake 60 is a gas operated brake cylinder 62 having a brake shoe 64 aligned with the rolling surface of a wheel 18. As shown in FIGS. 4 and 10, introduction of pressurized gas from the fluid supply system 40 into the brake cylinder 62 causes the brake shoe 64 to move outwardly from the brake cylinder and engage the surface of the wheel 18, thus preventing the wheel 18 from rolling. Release of the pressurized gas from the brake cylinder 62 causes the brake shoe 64 to retract back into the brake cylinder and away from the surface of the wheel 18, as shown in FIG. 9, and thus permit the wheel 18 to roll.

In a preferred embodiment of the present invention the wheel brakes 60 are constructed and intended that the shoe portion 64 of the wheel brake 60 be engaged when the apparatus is not moving in order to prevent the apparatus 10 from rolling when the apparatus 10 is left unattended. The wheel brake 60 is capable, however, of stopping the apparatus 10 while in motion, although doing so may cause an abrupt stoppage and may cause the packages on the pallet being carried by the apparatus to shift. If desired, the wheel brakes 60 and associated brake valves may be constructed to optimize the brake for use in bringing the apparatus to a stop.

As shown schematically in FIG. 4, the brake cylinders 62 are in fluid communication with the fluid supply system 40. The fluid supply system 40 includes a brake valve 66 downstream of the pressure regulator 44 to control the flow of pressurized gas to the brake cylinders 62. The brake valve 66, which is operated from the control panel 80, may be of any suitable type. Advantageously, a spool valve, shear-type-seal valve or other bidirectional valve may be used so that a single valve controls both the flow of pressurized gas into the brake cylinders 62 in order to move the brake shoes 64 into contact with the wheels and the release of pressurized gas from the brake cylinders 62 in order to retract the brake shoes 64. Alternatively, separate valves could be used to control the flow of pressurized gas into the brake cylinders 62 and the release of pressurized gas from the brake cylinders 62.

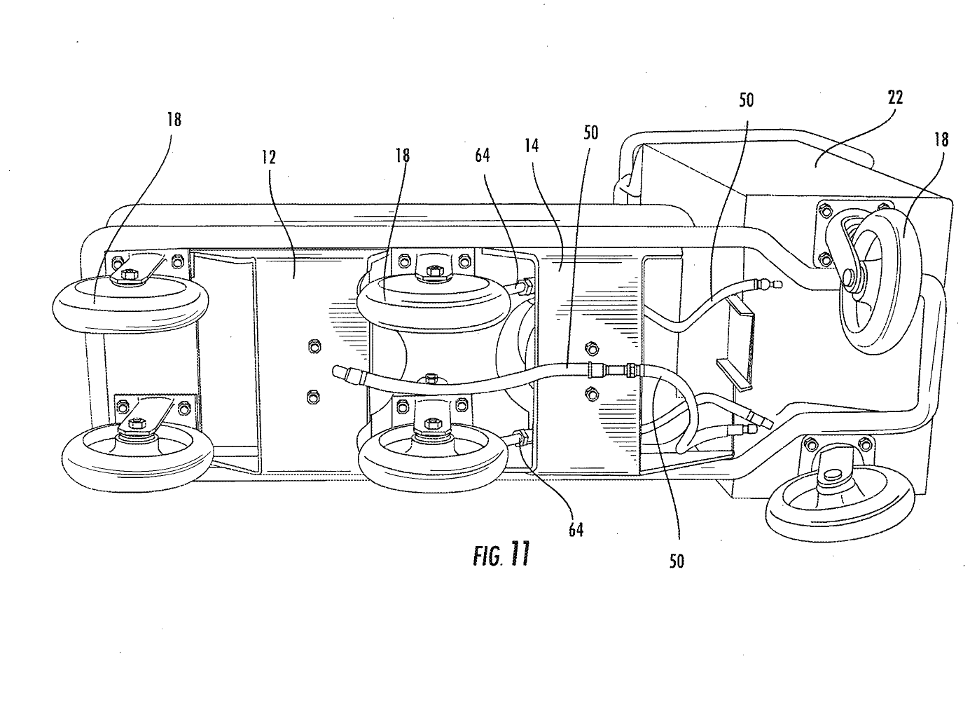

Any number of wheels 18 of the apparatus 10 may be configured to have a wheel brake 60. As illustrated in FIG. 11, an advantageous configuration includes three pairs of wheels 18 with the center pair of wheels 18 being configured to have wheel brakes 60.

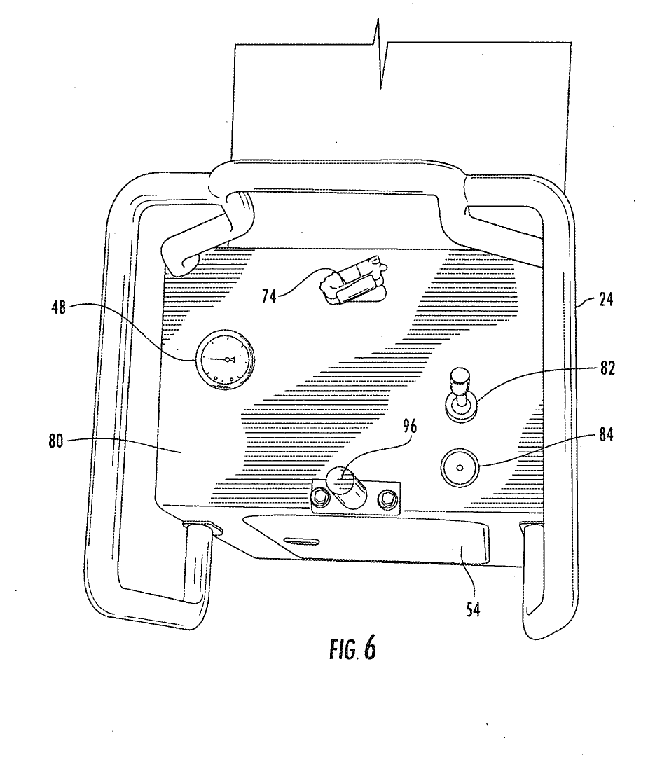

As shown in FIG. 6, a control panel 80 is disposed atop the vertical portion 16 of the frame 12. The control panel 80 may conveniently be located such that a person responsible for operating the apparatus 10 can access the control panel by standing adjacent to the apparatus 10. In a preferred embodiment in which the bladder valve 46 and the brake valve 66 are manually actuated valves, the control panel 80 includes a manual actuating lever 82 operatively connected to the bladder valve 46 and a brake valve actuator 84 operatively connected to the brake valve 66. In a preferred embodiment in which the bladder valve 46 and the brake valve 66 are not manually actuated, the control panel 80 includes actuating switches operatively connected to the bladder valve actuator and to the brake valve actuator. The control panel 80 may further include one or more pressure gauges 48 for monitoring the pressure of the supply tank 42 or the pressure at various points in the fluid supply system 40.

Manipulation of the manual actuating lever 82 to the inflating position causes the introduction of pressurized gas to the inflatable bladders 26 and thus moves the lift plate 20 from the first position to the second position. Manipulation of manual actuating lever 82 to the release position triggers the release of pressurized gas from the inflatable bladders 26 and thus returns the lift plate 20 from the second position to the first position. The manual actuating lever 82 may also have a neutral position whereby pressurized gas is neither introduced to nor released from the inflatable bladders 26.

Manipulation of the brake valve actuator 84 to the braking position causes introduction of pressurized gas to the brake cylinder 62 of the wheel brakes 60, thereby forcing the brake shoes 64 into direct physical engagement with the surface of the associated wheels 18. Manipulation of the brake valve actuator 84 to the release position causes release of pressurized gas from the brake cylinder 62 of the wheel brake 60, thereby causing the brake shoes 64 to retract from the surface of the associated wheels 18. The brake valve actuator 84 may also have a neutral position whereby pressurized gas is neither introduced to nor released from the brake cylinders 62 of the wheel brakes 60.

In a preferred embodiment wherein the supply tank 42 is a cylinder containing liquid carbon dioxide, the apparatus 10 provides a convenient way to replace the cylinder when the supply of carbon dioxide becomes exhausted or when replacement is otherwise desired. In such instances, the cylinder may be removed from the housing 22 of the apparatus 10 without disconnecting the cylinder from the fluid supply system 40. The primary valve of the cylinder is closed to seal the cylinder and prevent further release of pressurized fluid from the cylinder. The manual actuating lever 82 and brake valve actuator 84 are then manipulated to release any pressurized fluid that might remain in the fluid supply system 40. The empty cylinder can then be disconnected from the fluid supply system 40 and the pressure regulator 44 and replaced with a full cylinder. After the full cylinder is connected to the fluid supply system 40 and the pressure regulator 44, the primary valve of the cylinder is opened slightly to confirm whether any leaks exist in the connection of the cylinder. If leaks exist, the connection is checked or the cylinder replaced again. In the absence of leaks, the primary valve of the cylinder is reopened to facilitate a fluid communication with the full cylinder.

The frame 12 of the apparatus 10 may also include a center handle 96 positioned at or near the control panel 80 for permitting an operator to pull the apparatus over a threshold or obstacle on the ground or rolling surface. By grasping the center handle 96, an operator may tilt or shift the apparatus 10 such that the wheels 26 roll over the threshold or obstacle. The center handle 96 is preferably positioned on the frame 12 near the handlebars 24 to aid overall accessibility. As used herein, the general word “handle” is used to refer to either the handlebars 24 or the center handle 96 or to both.

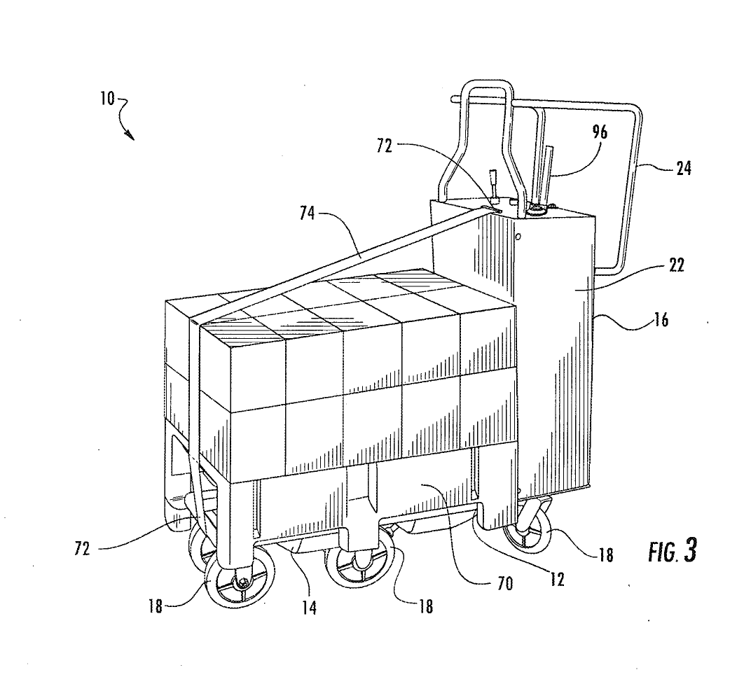

As shown in FIG. 3, the apparatus 10 may also include one or more tie points 72 and a load strap 74 for securing a loaded pallet 70 on the apparatus 10. In a preferred embodiment, tie points 72 are arranged at an end of the horizontal portion 14 of the frame farthest away from the vertical portion 16 of the frame 12 and at or near the top of the vertical portion 16, whereby attachment of the load strap 74 between such tie points 72 effectively secures the pallet 70 on the frame 12. In another preferred embodiment, the load strap 74 is retractably contained within the interior of the housing 22 and can be withdrawn and extended over a loaded pallet 70 and attached to the horizontal portion 14 of the frame 12 at a tie point 72. It is preferred that the load strap 74 be fastened over the pallet 70 whenever the lift plate 20 is in the second position and the apparatus 10 is being moved from one location to another.

The tie point 72 may be of any suitable shape or configuration, as would be understood by one of ordinary skill in the art. In a preferred embodiment, the tie points 72 are metal openings suitable for receiving a clasp, latch or hook on the load strap 74. The load strap 74 may be composed of any suitable material, such as a cargo strap. In a preferred embodiment, the load strap 74 is composed of a durable cloth material capable of multiple uses. The load strap 74 may also be configured such that the length of the load strap 74 is adjustable.

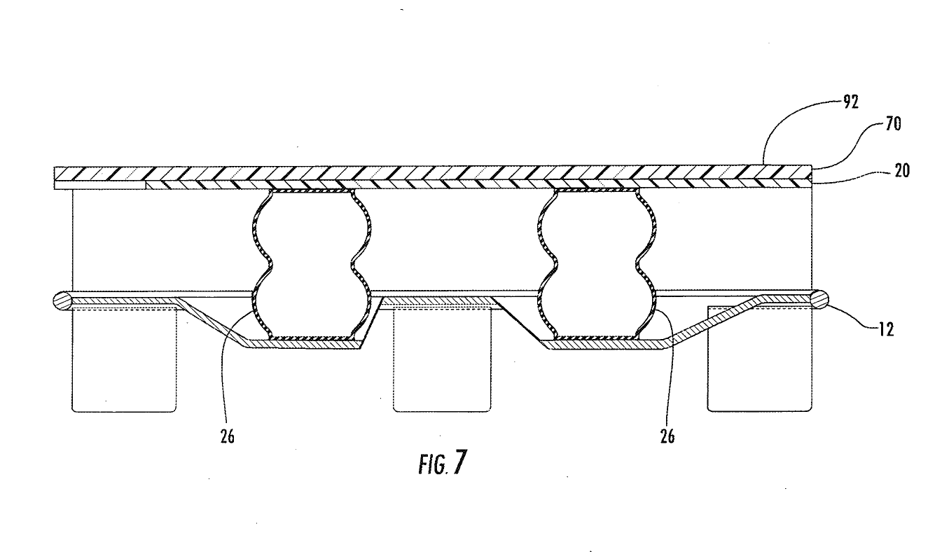

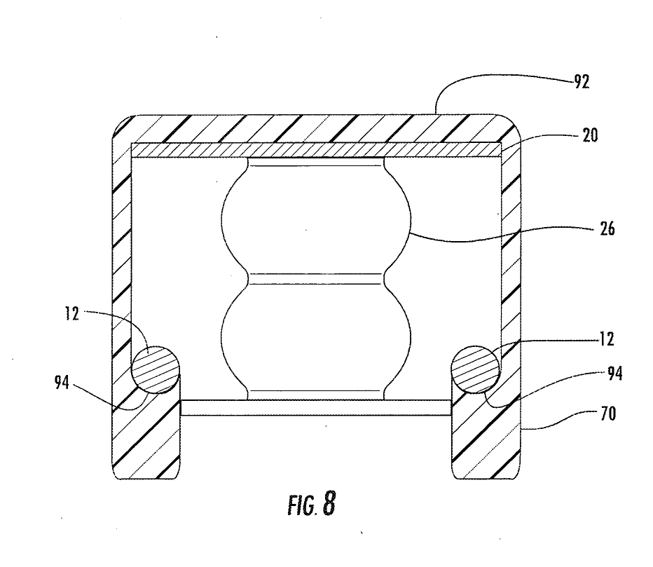

As shown in FIGS. 7 and 8, the present invention may be advantageously used in conjunction with a pallet 70 having a cross-sectional shape resembling an inverted “U” and two flanged channels 94 positioned so as to engage the frame 12 when the pallet is positioned on the pallet lift while in the second position. In operation, the lift plate 20 is placed substantially beneath the pallet face or deck 92 on which the load rests. As pressurized gas inflates the inflatable bladders 26, the lift plate 20 moves away from the horizontal portion 14 of the frame and, in so doing, contacts the pallet deck 92 and lifts the pallet 70 above the ground or other surface on which the pallet was resting. Additionally, as the pallet 70 is lifted, the flanged channels 94 engage the lower side of the horizontal portion 14 of the frame 12. Upon reaching the second position, wherein the apparatus 10 supports the pallet 70 above the ground or other surface, the upward force exerted by the lift plate 20 against the pallet deck 92 and the downward force exerted by the frame 12 against the flanged channels 94 effectively “lock” the pallet 70 to the apparatus 10. The pallet and its load can then be moved by pushing or pulling on the apparatus handle.

The present invention also includes a new and useful method of moving a loaded pallet. An operator of the apparatus 10 positions the apparatus 10 manually by pushing or pulling the apparatus 10 by the handle attached to the vertical portion 16 of the frame 12. To prepare for moving a pallet 70, with the lift plate in the first position the apparatus 10 is positioned such that a portion of the lift plate 20 is between the pallet deck 92 and the ground or surface upon which the pallet is resting. The apparatus 10 may advantageously be positioned such that the lift plate 20 is substantially completely beneath the pallet deck. Once the apparatus 10 is so positioned, the operator moves the brake valve actuator 84 on the control panel 80 to the braking position and thus initiates flow of pressurized gas to the inflatable wheel brakes 60. Introduction of pressurized gas to the wheel brake cylinders 62 forces the brake shoes 64 into frictional engagement with the associated wheels 18 and thus prevents the apparatus 10 from rolling.

While the apparatus 10 is prevented from rolling, the operator moves the manual actuating lever 82 on the control panel 80 to the inflating position and thus initiates flow of pressurized gas to the inflatable bladders 26. Introduction of pressurized gas to the inflatable bladders 26 expands the bladders 26 and thereby causes the lift plate 26 to move from the first position to the second position, whereby the pallet 70 is supported above the surface of the ground upon which the pallet was resting. After the lift plate 26 reaches the second position, the operator may move the manual actuating lever 82 to the neutral position. The load strap 74 is then attached to one or more tie points 72 to secure the pallet 70 to the apparatus 10.

Once the pallet 70 is supported above the ground or other surface, the operator then moves the brake valve actuator 84 on the control panel 80 to the release position, thereby releasing pressurized gas from the inflatable wheel brake cylinders 62 and causing the brake shoes 64 to move away from the surface of the associated wheels 18. The apparatus 10, now fully supporting a loaded pallet 70, is now ready to be moved manually to a desired location by pulling or pushing on the handle.

Once the apparatus 10 has reached the desired location, the operator moves the brake valve actuator 84 on the control panel 80 to the braking position to prevent the apparatus 10 from rolling. The load strap 74 is detached from the tie points 72. The manual actuating lever 82 on the control panel 80 is moved to the release position, thereby releasing pressurized gas from the inflatable bladders 26 and returning the lift plate 20 from the second position to the first position. Once the lift plate 20 has returned to the first position, the pallet 70 is supported by the ground or other surface and the operator may move the manual actuating lever 82 to the neutral position. The operator can then move the brake valve actuator 84 on the control panel 80 to the release position to release pressurized gas from the inflatable wheel brake 60. The apparatus 10 can then be rolled away from the pallet 70.

The present invention thus overcomes the disadvantages associated with the conventional beverage delivery system in which individual beverage cases are loaded onto a side bay delivery truck and then unloaded by a delivery person and transported into a customer location using a conventional hand truck. Using the present invention, pallets corresponding to each customer's order can be loaded onto a conventional delivery truck (not a side bay truck). When the delivery truck arrives at a customer location, the pallet or pallets corresponding to such customer's order can be quickly and easily offloaded by a delivery person using the apparatus and method of the present invention. Additionally, the apparatus may further be utilized in the movement of multiple empty pallets simultaneously. Pallets that are empty may be stacked, one on top of another, so as to permit the apparatus to be positioned with respect to the lowermost pallet in the stack.

Based on the foregoing information, it is readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to its preferred embodiment(s), it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

1. An apparatus for lifting and moving a pallet positioned on a surface comprising:
a frame having a plurality of wheels and a handle attached thereto;
a lift plate movable between a first position wherein said lift plate is adjacent a portion of said frame and a second position wherein said lift plate is spaced from such portion of said frame; and
at least one inflatable bladder positioned between said lift plate and such portion of said frame such that inflation of said at least one inflatable bladder moves said lift plate from the first position to the second position,
wherein inflating said at least one inflatable bladder with said lift plate in the first position and located between the surface and a portion of the pallet moves said lift plate to the second position, thereby contacting the pallet and raising the pallet off of the surface, whereafter the pallet can be moved by pushing or pulling the handle to roll the frame over the surface with the pallet supported thereon by said lift plate.

2. A pallet lifting and moving apparatus as defined in claim 1 further comprising means for inflating and deflating said at least one inflatable bladder.

3. A pallet lifting and moving apparatus as defined in claim 1 further comprising on said frame a fluid supply system comprising:
a tank of pressurized liquid;
one or more regulators in fluid communication with the tank of pressurized liquid and capable of reducing pressure in the fluid supply system downstream of the one or more regulators to a pressure at which the liquid in the tank of pressurized liquid becomes a gas; and
a bladder valve in fluid communication with the one or more regulators and with the at least one bladder;
wherein opening the bladder valve permits gas in the fluid supply system downstream of the one or more regulators to flow into and inflate the at least one inflatable bladder.

4. A pallet lifting and moving apparatus as defined in claim 3 further comprising a liquid accumulator in the fluid supply system downstream of the one or more regulators and in fluid communication with the one or more regulators and with the bladder valve.

5. A pallet lifting and moving apparatus as defined in claim 3 wherein the bladder valve has a first position that permits gas in the fluid supply system to flow into the at least one inflatable bladder, a second position that does not permit gas to flow into or out of the at least one inflatable bladder, and a third position that permits gas to flow out of the at least one inflatable bladder

6. A pallet lifting and moving apparatus as defined in claim 3 wherein the fluid supply system further comprises:
at least one brake in fluid communication with the one or more regulators having a gas operated brake cylinder and a brake shoe and being adapted and positioned such that pressurized gas entering into the gas operated brake cylinder moves the brake shoe into contact with at least one wheel of the plurality of wheels; and
a brake valve in fluid communication with the one or more regulators and with the brake;
wherein opening the brake valve permits gas in the fluid supply system to flow into the brake cylinder and move the brake shoe into contact with the at least one wheel.

7. A pallet lifting and moving apparatus as defined in claim 6 wherein the brake valve has a first position that permits gas in the fluid supply system to flow into the gas operated brake cylinder and a second position that permits gas to flow out of the gas operated brake cylinder.

8. A pallet lifting and moving apparatus as defined in claim 3 wherein the pressurized liquid comprises liquid carbon dioxide.

9. A pallet lifting and moving apparatus as defined in claim 8 wherein the pressure of the liquid carbon dioxide in the tank of pressurized liquid is between 500 PSI and 2000 PSI.

10. A pallet lifting and moving apparatus as defined in claim 9 wherein the pressure of the gas downstream of the one or more regulators is between 70 PSI and 120 PSI.

11. A pallet lifting and moving apparatus as defined in claim 1 wherein at least one wheel of the plurality of wheels is attached to said frame such that it rolls about a generally horizontal axis and swivels about a generally vertical axis.

12. A pallet lifting and moving apparatus as defined in claim 6 further comprising a control panel having a first manual valve actuator operatively connected to the bladder valve such that bladder valve can be opened or closed using the first manual valve actuator and having a second manual valve actuator operatively connected to the brake valve such that the brake valve can be opened or closed using the second manual valve actuator.

13. A pallet lifting and moving apparatus as defined in claim 1 wherein the diameter of at least one wheel of the plurality of wheels is greater than the diameter of at least one other wheel of the plurality of wheels.

14. A pallet lifting and moving apparatus as defined in claim 1 further comprising a housing attached to said frame and a stabilizing plate attached to said lifting plate and adapted and positioned to move within a constrained channel on said housing during movement of said lifting plate between the first position and the second position to thereby maintain said lifting plate substantially horizontal during such movement.

15. An apparatus for lifting and moving a pallet positioned on a surface comprising:
a frame having a handle and an elongate portion with a lower side and an upper side;
a plurality of wheels mounted to the lower side of the elongate portion of said frame;
a lift plate movable between a first position wherein said lift plate is adjacent the upper side of the elongated portion of said frame and a second position wherein said lift plate is spaced from the upper side of the elongated portion of said frame;
a pair of inflatable bladders, each bladder of said pair of inflatable bladders being spaced from the other bladder of said pair of inflatable bladders and each bladder of said pair of inflatable bladders being mounted to said lift plate and to the upper side of the elongate portion of said frame;
a supply tank containing pressurized liquid on said frame;
at least one regulator in fluid communication with said supply tank and capable of reducing the pressure of the pressurized liquid in said supply tank to a pressure at which such pressurized fluid becomes a gas; and
a first valve in fluid communication with said regulator and each bladder of said pair of inflatable bladders;
wherein opening said first valve when said lift plate is in the first position and located between the surface and a portion of the pallet inflates the pair of inflatable bladders and thereby moves said lift plate into contact with the pallet and raises the pallet off of the surface when said lift plate is in the second position, whereafter the pallet can be moved by pushing or pulling the handle to roll the frame over the surface with the pallet supported thereon by said lift plate.

16. A pallet lifting and moving apparatus as defined in claim 15 wherein said first valve has a first position that permits gas to flow into each bladder of the pair of inflatable bladders, a second position that does not permit gas to flow into or out of either bladder of the pair of inflatable bladders, and a third position that permits gas to flow out of each bladder of the pair of inflatable bladders.

17. A pallet lifting and moving apparatus as defined in claim 16 further comprising a manual valve actuator operatively connected to said first valve that controls the position of said first valve.

18. A pallet lifting and moving apparatus as defined in claim 15 further comprising:
at least one brake having a brake shoe and a gas operated brake cylinder in fluid communication with the at least one regulator and being adapted and positioned such that pressurized gas entering into the gas operated brake cylinder moves the brake shoe into contact with at least one wheel of the plurality of wheels; and
a second valve in fluid communication with the at least one regulator and with the brake;
wherein opening the second valve permits gas to flow into the brake cylinder and move the brake shoe into contact with the at least one wheel.

19. A pallet lifting and moving apparatus as defined in claim 18 wherein said second valve has a first position that permits gas to flow into gas operated brake cylinder and a second position that permits gas to flow out of the gas operated brake cylinder.

20. A pallet lifting and moving apparatus as defined in claim 19 further comprising a manual valve actuator operatively connected to said second valve that controls the position of said second valve.

21. A pallet lifting and moving apparatus as defined in claim 15 further comprising a liquid accumulator in fluid communication with the at least one regulator and with the first valve.

22. A pallet lifting and moving apparatus as defined in claim 15 wherein the pressurized liquid is liquid carbon dioxide.

23. A pallet lifting and moving apparatus as defined in claim 22 wherein the pressure of the gas downstream of the at least one regulator is between 70 PSI and 120 PSI.

24. A pallet lifting and moving apparatus as defined in claim 15 wherein at least one wheel of the plurality of wheels is attached to said frame such that it rolls about a generally horizontal axis and swivels about a generally vertical axis.

25. A pallet lifting and moving apparatus as defined in claim 15 wherein the diameter of at least one wheel of the plurality of wheels is greater than the diameter of at least one other wheel of the plurality of wheels.

26. A pallet lifting and moving apparatus as defined in claim 15 further comprising a housing attached to said frame and a stabilizing plate attached to said lifting plate and adapted and positioned to move within a constrained channel on said housing during movement of said lifting plate between the first position and the second position to thereby maintain said lifting plate substantially horizontal during such movement.

27. A method of delivering palletized beverages comprising:
positioning on a floor of a delivery truck one or more pallets loaded with beverages corresponding to beverages ordered by a customer;
driving the delivery truck to a customer's building, such building having a floor;
rolling a lifting plate between the floor of the delivery truck and one pallet of the one or more pallets;
raising the lifting plate by inflating one or more inflatable bladders beneath the lifting plate to thereby lift the one pallet off of the floor of the delivery truck;
transporting the one pallet on the raised lifting plate from the delivery truck to the customer's building; and
lowering the lifting plate by deflating the one or more inflatable bladders beneath the lifting plate, thereby lowering the one pallet until the one pallet rests on the floor of the customer's building.

28. A method of delivering palletized beverages as defined in claim 27 wherein the lifting plate is disposed on a wheeled frame and one or more inflatable bladders are disposed between the lifting plate and a portion of the wheeled frame such that inflation of the one or more inflatable bladders using pressurized gas raises the lifting plate.

29. A method of delivering palletized beverages as defined in claim 27 wherein the wheeled frame also includes a supply of pressurized gas.

30. A method of delivering palletized beverages as defined in claim 29 wherein the pressurized gas is pressurized carbon dioxide.

31. A method of delivering palletized beverages as defined in claim 27 wherein the one or more inflatable bladders beneath the lifting plate are inflated with carbon dioxide.

32. A method of delivering palletized beverages as defined in claim 27 wherein the one or more pallets loaded with beverages are positioned on the floor of the delivery truck in reverse order to the order that the one or more pallets loaded with beverages are delivered to customer buildings.
